(19) United States
(12) Patent Application Publication
(10) Pub. No.: US 2023/0057459 A1
(43) Pub. Date: Feb. 23, 2023

(54) METHOD OF PROVIDING CLEAN AIR, CLEAN WATER, AND/OR HYDRAULIC CEMENT AT WELL SITES

(71) Applicant: Halliburton Energy Services, Inc., Houston, TX (US)

(72) Inventors: Philip D. NGUYEN, Houston, TX (US); Tatyana Vladimirov KHAMATNUROVA, Houston, TX (US); Ronald Glen DUSTERHOFT, Houston, TX (US)

(21) Appl. No.: 17/407,381

(22) Filed: Aug. 20, 2021

(51) Int. Cl. C02F 1/52; C04B 14/28; C09K 8/46; C01F 11/18; C01F 5/24; E21B 43/26; B01D 53/62; B01D 53/78

(52) U.S. Cl. CPC C02F 1/5236; C04B 14/28; C09K 8/46; C01F 11/181; C01F 5/24; E21B 43/26; B01D 53/62; B01D 53/78; C02F 2103/10

(57) ABSTRACT

A method including reacting, at a jobsite, a total dissolved solids (TDS) water with a gas comprising carbon dioxide (CO₂) in the presence of a proton-removing agent to produce a CO₂-reduced gas and an aqueous product comprising water and a precipitate, wherein the TDS water comprises produced water, wherein the precipitate comprises one or more carbonates, and wherein the CO₂-reduced gas comprises less CO₂ than the gas comprising CO₂; and separating at least a portion of the water from the aqueous product to provide a concentrated slurry of the precipitate and a TDS-reduced water, wherein the TDS-reduced water comprises less TDS than the TDS water.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The present disclosure relates generally to methods of providing clean air, clean water, and/or hydraulic cement at well sites or other jobsites by sequestering produced exhaust gas and water comprising a high total dissolved solids (TDS) content. More specifically, this disclosure relates to precipitating carbonates by reaction of cations in a high TDS water with carbon dioxide (CO₂) in a gas comprising CO₂ in the presence of a proton-removing agent, to provide clean air, that can optionally be vented to atmosphere, and one or more products, including a concentrated slurry comprising the carbonates and/or a TDS-reduced water, which products can be utilized to advantage at the well sites or other jobsites.

### BACKGROUND

The embodiments herein relate to the utilization of exhaust gas from machinery located and operated at a jobsite (such as, but not limited to a well site). Exhaust gas is produced at numerous jobsites. For example, oil and gas wells produce oil, gas, and/or byproducts from subterranean formation hydrocarbon reservoirs. A variety of subterranean formation operations are utilized to obtain such hydrocarbons, such as drilling operations, completion operations, stimulation operations, production operations, enhanced recovery operations, and the like. Such subterranean formation operations typically use a large number of vehicles, heavy equipment, and other apparatus (collectively referred to as “machinery” herein) in order to achieve certain job requirements, such as treatment fluid pump rates. Such equipment may include, for example, pump trucks, sand trucks, cranes, conveyance equipment, mixing machinery, and the like. Many of these operations machinery utilize combustion engines that produce exhaust gases (e.g., comprising carbon dioxide/greenhouse gas emissions) that are emitted into the atmosphere. Such atmospheric exhaust gas can be hazardous to the environment and the health of human and animal life.

Natural resources (e.g., oil or gas) residing in a subterranean formation can be recovered by driving resources from the formation into a wellbore using, for example, a pressure gradient that exists between the formation and the wellbore, the force of gravity, displacement of the resources from the formation using a pump or the force of another fluid injected into the well or an adjacent well. A number of wellbore servicing fluids can be utilized during the formation and production from such wellbores. For example, in aspects, the production of fluid in the formation can be increased by hydraulically fracturing the formation. That is, a treatment fluid (e.g., a fracturing fluid) can be pumped down the wellbore to the formation at a rate and a pressure sufficient to form fractures that extend into the formation, providing additional pathways through which the oil or gas can flow to the well. Subsequently, oil or gas residing in the subterranean formation can be recovered or “produced” from the well by driving the fluid into the well. During production of the oil or gas, substantial quantities of produced water, which can contain high levels of total dissolved solids (TDS), can also be produced from the well.

Accordingly, an ongoing need exists for improved systems and methods for preventing or reducing amounts of CO₂ released into the atmosphere at a jobsite (such as a well site) and reducing amounts of produced water for disposal at the or another jobsite.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic illustration of a method according to one or more embodiments of this disclosure;

FIG. 2 is a schematic illustration of a system according to one or more embodiments of the present disclosure;

FIG. 3 is a schematic of a plurality of machinery that may be located and operated at an exemplary jobsite (e.g., a well site for performing a subterranean formation operation) and may produce a gas comprising CO₂, according to one or more embodiments of the present disclosure;

FIG. 4A is a schematic of an exemplary system from which a gas comprising CO₂ and/or a produced water can be produced and/or one or more products of the method (e.g., wellbore treatment fluids and/or oil well cement) can be utilized, according to one or more embodiments of the present disclosure;

FIG. 4B is a schematic of an exemplary system from which a gas comprising CO₂ can be produced and/or one or more products of the method (e.g., wellbore treatment fluids and/or oil well cement) can be utilized, according to one or more embodiments of the present disclosure; and

FIG. 5 is a schematic representation of one or more jobsites from which the produced water and/or the gas comprising CO₂ can be obtained/produced and/or at which the TDS-reduced water and/or the concentrated slurry can be utilized, according to one or more embodiments of this disclosure.

### DETAILED DESCRIPTION

It should be understood at the outset that although an illustrative implementation of one or more embodiments are provided below, the disclosed systems and/or methods can be implemented using any number of techniques, whether currently known or in existence. The disclosure should in no way be limited to the illustrative implementations, drawings, and techniques below, including the exemplary designs and implementations illustrated and described herein, but can be modified within the scope of the appended claims along with their full scope of equivalents.

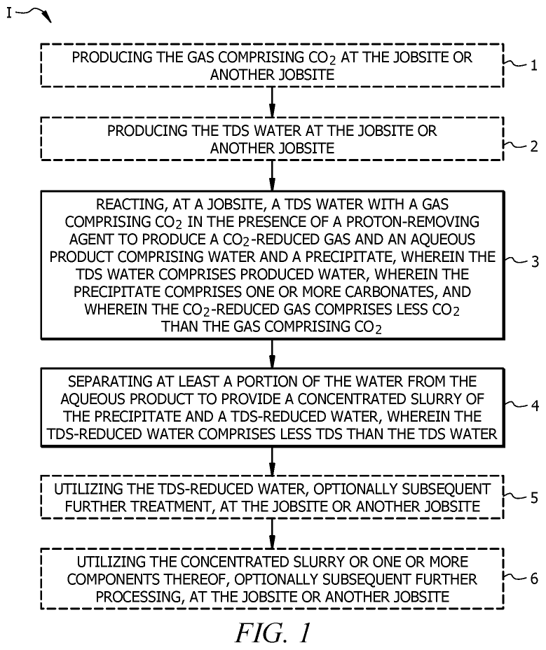

The “jobsite” generally refers to the jobsite at which an aqueous product and/or a total dissolved solids (TDS)-reduced water and a concentrated slurry separated therefrom are produced via steps 3 and/or 4 of method I of FIG. 1 are performed. Reference to “another” jobsite, indicates a different jobsite from the jobsite at which the aqueous product and/or the total dissolved solids (TDS)-reduced water and the concentrated slurry separated therefrom were produced, at which another jobsite the TDS-reduced water and/or the concentrated slurry (or one or more components thereof) may be utilized, or yet another different jobsite at which a TDS water and/or a gas comprising CO₂ (or a waste gas from which the gas comprising CO₂ is obtained) utilized in Steps 3 and 4 of the method I are produced/obtained.

Disclosed herein are systems and methods for producing clean air, clean water, and optionally one or more valuable products or components thereof (collectively referred to herein as “products”), such as, without limitation, cement (e.g., oil well cement, industrial cement, etc.) or a component thereof, concrete or a component thereof, propping agent, or a combination thereof, from produced water and gas (e.g., exhaust gas) comprising carbon dioxide (CO₂).

FIG. 1 is a schematic illustration of a method I according to one or more embodiments of this disclosure. As depicted in FIG. 1, method I comprises, at 3, reacting, at a jobsite, a total dissolved solids (TDS) water with a gas comprising carbon dioxide (CO₂) in the presence of a proton-removing agent to produce a CO₂-reduced gas and an aqueous product comprising water and a precipitate, wherein the TDS water comprises produced water, wherein the precipitate comprises one or more carbonates, and wherein the CO₂-reduced gas comprises less CO₂ than the gas comprising CO₂; and, at 4, separating at least a portion of the water from the aqueous product to provide a concentrated slurry of the precipitate and a TDS-reduced water, wherein the TDS-reduced water comprises less TDS than the TDS water.

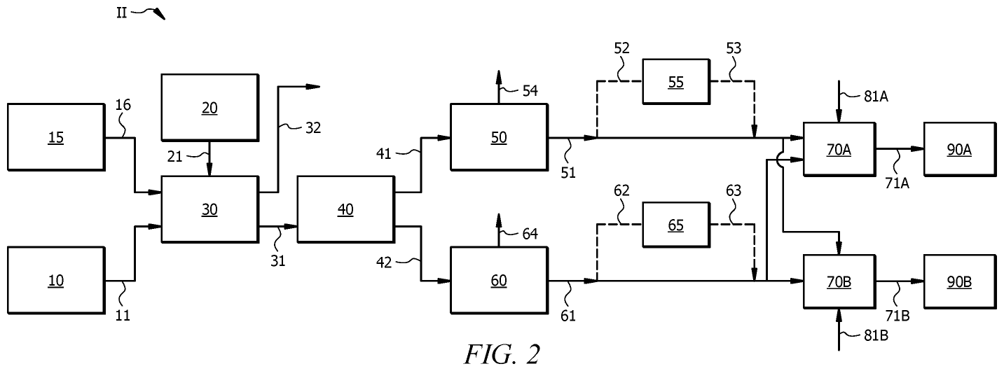

As depicted in FIG. 2, which is a schematic illustration of a system II according to one or more embodiments of the present disclosure, reacting, at the jobsite, the TDS water 15 with the gas comprising CO₂ 10 in the presence of a proton-removing agent 20 to produce the CO₂-reduced gas 32 and the aqueous product 31 comprising water and the precipitate at 3 can be effected in a precipitation reactor 30. The TDS water 15 can be introduced into the precipitation reactor 30 via a TDS water line 16; the gas comprising CO₂ 10 can be introduced into the precipitation reactor 30 via gas comprising CO₂ line 11, and the proton-removing agent 20 can be introduced into the precipitation reactor 30 via a proton-removing agent line 21. Although depicted as introduced separately into precipitation reactor 30, it is envisaged that, in embodiments, one or more of the gas comprising CO₂ 10, the TDS water 15, and/or the proton-removing agent 20 can be combined prior to introduction into precipitation reactor 30. For example, in embodiments, the TDS water 15 can be combined with the gas comprising CO₂ 10, and introduced into precipitation reactor 30 separately from the proton-removing agent 20.

The precipitation reactor 30 can comprise a Venturi reactor, a fluidized bed reactor, a fixed bed reactor, a slurry bubble column reactor, a batch reactor, a semi-batch reactor a continuous stirred tank reactor, a plug flow reactor, another suitable reactor, another suitable reactor, or a combination thereof. In specific applications precipitation reactor 30 includes a Venturi reactor.

As detailed further herein, the TDS water 15, the gas comprising CO₂ 10, or both the TDS water 15 and the gas comprising CO₂ 10 can be produced at the jobsite. Alternatively, the TDS water 15, the gas comprising CO₂ 10, or both the TDS water 15 and the gas comprising CO₂ 10 can be produced at one or more jobsites other than the jobsite at which steps 3 and/or 4 of the method I are carried out. To avoid transport (e.g., via railway, truck, tanker, pipeline, etc.) of large volumes of gas or water, it can be desirable, in embodiments, that the TDS water 15, the gas comprising CO₂ 10, or both the TDS water 15 and the gas comprising CO₂ 10 are produced at the jobsite. However, in aspects, the TDS water 10 is produced at a first different jobsite (i.e., not at the jobsite at which steps 3 and/or 4 of method I are performed), and/or the gas comprising CO₂ is produced at a second different jobsite (i.e., not at the jobsite at which steps 3 and/or 4 of method I are performed), which second different jobsite may be the same as or different from the first different jobsite at which the TDS water 15 is produced. Any or all of the jobsite, the first different jobsite, and the second different jobsite can, in embodiments, be a well site.

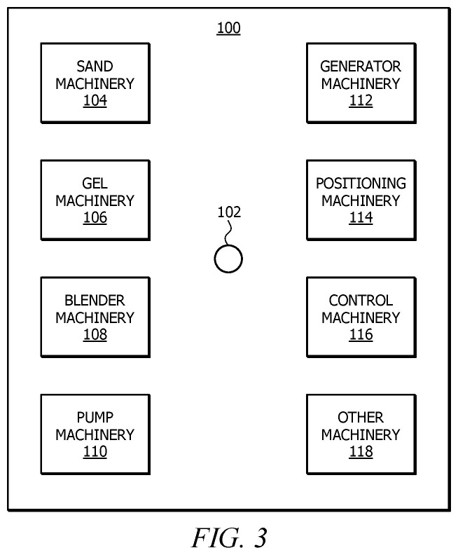

As noted above, the gas comprising CO₂ 10 can be produced at the jobsite and/or at another jobsite. With reference back to FIG. 1, the method can further comprise, at 1, producing (and/or obtaining) the gas comprising CO₂ at the jobsite or another jobsite. Generally, the gas comprising CO₂ can be any gas comprising CO₂, for example, comprising a greater amount of CO₂ than air. For example, in embodiments, the gas comprising CO₂ can comprise greater than or equal to about 5, 6, 7, 8, 9, 10, 20, 30, 40, 50, 60, 70, 80, 90, 95, or 100 volume percent (vol. %) CO₂. By way of examples, the gas comprising CO₂ 10 can comprise a waste gas, or one or more components thereof, produced at the or another jobsite, such as, without limitation, one or more well sites or industrial plants. The one or more industrial plants can include, without limitation, a cement plant, a chemical processing plant, a mechanical processing plant, a refinery, a steel plant, a power plant (e.g., a gas power plant, a coal power plant, etc.), or a combination and/or a plurality thereof. In aspects, the gas comprising CO₂ 10 includes a waste gas that is a product of fuel combustion, for example, the product of an internal combustion engine, or a gas fired turbine engine, such as, for example, from a microgrid having electric pumps. In aspects, the internal combustion engine comprises an engine fueled by diesel, natural gas, gasoline, or a combination thereof (e.g., a diesel engine, or a hybrid engine that is fueled by diesel and natural gas). In specific embodiments, the jobsite and/or the another jobsite is a well site. In such aspects, at 1, the gas comprising CO₂ 10 can be produced at the well site of the jobsite and/or the another jobsite. FIG. 3 depicts an exemplary plurality of machinery that may be located and operated at a well site for performing a subterranean formation operation, according to one or more embodiments of the present disclosure, and from which the gas comprising CO₂ 10 can be obtained. As depicted in FIG. 3, the well site 100 may comprise a wellbore 102 for which machinery is used to perform a formation operation. The machinery may include one or more internal combustion or other suitable engines that consume fuel to perform work at the site 100 and produce exhaust gas comprising CO₂.

The wellbore 102 may be a hydrocarbon-producing wellbore (e.g., oil, natural gas, and the like) or another type of wellbore for producing other resources (e.g., mineral exploration, mining, and the like). FIG. 3, however, depicts a well site 100 having machinery typically associated with a subterranean formation operation related to a hydrocarbon producing wellbore, where such operations may comprise, for example, a cementing operation, a fracturing operation, or other suitable operation where equipment is used to drill, complete, produce, enhance production, and/or work over the wellbore 102. Although not shown, other surface operations may include, for example, operating or construction of a facility.

With continued reference to FIG. 3, the well site 100, for the illustrated embodiment, includes various non-limiting machinery labeled as sand machinery 104, gel machinery 106, blender machinery 108, pump machinery 110, generator machinery 112, positioning machinery 114, control machinery 116, and other machinery 118. The machinery may be, for example, truck, skid or rig-mounted, or otherwise present at the well site 100, without departing from the scope of the present disclosure. The sand machinery 104 may include transport trucks or other vehicles for hauling to and storing at the well site 100 sand for use in an operation. The gel machinery 106 may include transport trucks or other vehicles for hauling to and storing at the well site 100 materials used to make a gelled treatment fluid for use in an operation. The blender machinery 108 may include blenders, or mixers, for blending materials at the well site 100 for an operation. The pump machinery 110 may include pump trucks or other vehicles or conveyance equipment for pumping materials down the wellbore 102 for an operation. The generator machinery 112 may include generator trucks or other vehicles or equipment for generating electric power at the well site 100 for an operation. The electric power may be used by sensors, control machinery 116, and other machinery 118. The positioning equipment 114 may include earth movers, cranes, rigs or other equipment to move, locate or position equipment or materials at the well site 100 or in the wellbore 102.

The control machinery 116 may include an instrument truck coupled to some, all, or substantially all of the other equipment at the well site 100 and/or to remote systems or equipment. The control machinery 116 may be connected by wireline or wirelessly to other equipment to receive data for or during an operation. The data may be received in real-time or otherwise. In another embodiment, data from or for equipment may be keyed into the control machinery 116.

The control machinery 116 may include a computer system for planning, monitoring, performing or analyzing the job. Such a computer system may be part of a distributed computing system with data sensed, collected, stored, processed and used from, at or by different equipment or locations. The other machinery 118 may comprise equipment also used at the well site 100 to perform an operation.

In other examples, the other machinery 118 may comprise personal or other vehicles used to transport workers to the well site 100 but not directly used at the well site 100 for performing an operation.

Many if not most of these various machinery at the well site 100 accordingly utilize a diesel or other fuel types to perform their functionality. Such fuel is expended and exhausted as exhaust gas, such as exhaust gas comprising CO₂, considered a significant greenhouse gas and contributor to ocean acidification. The embodiments described herein provide a process for capturing, absorbing, and, when applicable, reusing CO₂ from such machinery located and operated at a well site, thus reducing atmospheric CO₂ emissions, while reducing material and time costs. It is to be appreciated that other configurations of the well site 100 may be employed, without departing from the scope of the present disclosure. FIG. 3 is merely an example to illustrate that a number of various machinery at a jobsite (e.g., a well site) may utilize diesel or other fuel that creates exhaust gas comprising CO₂ that may conventionally be exhausted into the atmosphere, but herein utilized to form one or more desired products.

In some embodiments described herein, the present disclosure provides capturing exhaust gas comprising CO₂ from such machinery located and operated at a well site and utilizing such exhaust gas as the gas comprising CO₂ 10.

Although described hereinabove with reference to a well site, the source of the gas comprising CO₂ 10 that is contacted with the TDS water 15 in the method I may be any convenient CO₂ source. The CO₂ source is a gaseous CO₂ source. This gaseous CO₂ may vary widely, ranging from air, industrial waste streams, etc. As noted above, the gaseous CO₂ can, in certain instances, comprise a waste product from an industrial plant. The nature of the industrial plant may vary in these embodiments, where industrial plants of interest include power plants, chemical processing plants, and other industrial plants that produce CO₂ as a byproduct. By waste stream is meant a stream of gas (or analogous stream) that is produced as a byproduct of an active process of the industrial plant, e.g., an exhaust gas. The gaseous stream may be substantially pure CO₂ or a multi-component gaseous stream that includes CO₂ and one or more additional gases. Multi-component gaseous streams (containing CO₂) that may be employed as a CO₂ source in embodiments of the subject methods include both reducing, e.g., syngas, shifted syngas, natural gas, and hydrogen and the like, and oxidizing condition streams, e.g., flue gases from combustion. Particular multi-component gaseous streams of interest that may be treated according to the subject invention include: oxygen containing combustion power plant flue gas, turbo charged boiler product gas, coal gasification product gas, shifted coal gasification product gas, anaerobic digester product gas, wellhead natural gas stream, reformed natural gas or methane hydrates, and the like.

In aspects, the gas comprising CO₂ 10 comprises greater than or equal to about 5, 6, 7, 8, 9, 10, 15, 20, 25, 30, 40, 50, 60, 70, 80, 90, 95, 96, 97, 98, 99, or 100 volume percent (vol %) CO₂. In aspects, the gas comprising CO₂ 10 comprises primarily CO₂ (e.g., greater than or equal to about 50, 60, 70, 80, 90, 95, 96, 97, 98, 99, or 100 volume percent (vol %) CO₂). For example, when the gas comprising CO₂ 10 is obtained from a waste gas produced at a different jobsite (e.g., at an another jobsite) than the jobsite at which steps 3 of method I is performed, CO₂ can be separated from the waste gas in order to reduce a volume of gas to be transported to the jobsite at which step 3 is performed. For example, when the gas comprising CO₂ includes a flue gas from a power plant, which typically contains from about 7 to about 10 vol. % CO₂, the method I can further comprise transporting the gas comprising CO₂ 10 (or a waste gas from which the gas comprising CO₂ is obtained) from the another jobsite at which the waste gas is obtained to the jobsite. In embodiments, the method I can further comprise separating the gas comprising CO₂ 10 from the waste gas comprising CO₂, to reduce a volume of gas, e.g., for transport. Although the separating of the gas comprising CO₂ 10 from the waste gas comprising CO₂ can be performed at the jobsite at which step 3 of the method I is performed (e.g., after transport of the waste gas from the another jobsite at which the waste gas is obtained and/or produced to the jobsite at which step 3 is performed), to facilitate transportation, the separating of the gas comprising CO₂ 10 from the waste gas comprising CO₂ can be performed at the another jobsite at which the waste gas is produced and/or obtained and subsequently, the gas comprising CO₂ 10 can be transported to the jobsite at which step 3 of the method I is performed. Separating the gas comprising CO₂ 10 from the waste gas comprising CO₂ can further comprise separating via amine absorption, calcium oxide (CaO) absorption, filtration, packed bed, another technique, or a combination thereof. Accordingly, when present, the separating of the gas comprising CO₂ 10 from the waste gas comprising CO₂ can be effected at another jobsite and (e.g., only) the gas comprising CO₂ 10 transported to the jobsite at which step 3 of method I is performed.

The TDS water 15 and/or the produced water contained in the TDA water 15 comprises one or more ions, wherein the ions can comprise divalent cations, monovalent cations, or a combination thereof. In embodiments, the ions are selected from calcium, magnesium, sodium, potassium, aluminum, iron, boron, sulfur, silicon, strontium, or a combination thereof. For example, the divalent cations can include calcium, magnesium, or a combination thereof, in which case the one or more carbonates of the precipitate can include calcium carbonate, magnesium carbonate, or a combination thereof, respectively.

The TDS water 15 includes produced water, and can, in embodiments, further include industrial waste water, seawater, brine, hard water, freshwater, tap water, city water, or a combination thereof. In aspects, cations (e.g., materials comprising the cations) can be added to low-TDS waters (e.g., water comprising less than about 200, 500, 1000, 1500, 2,000, 2500, 3000, 3500, 4000, 4500, or 5,000 ppm TDS), when such low TDS water is utilized in combination with the produced water to provide the TDS water 15. The produced water can be a product of a wellbore servicing operation on a well at the jobsite or another jobsite comprising a well site.

In aspects, TDS water 15 comprises from about 10,000 to about 350,000 parts per million (ppm) (from about 1 to about 35 weight percent (wt %)), from about 100,000 to about 300,000 ppm (from about 10 to about 30 weight percent (wt %)), or from about 150,000 to about 300,000 ppm (from about 15 to about 30 weight percent (wt %)) TDS. In aspects, TDS water 15 comprises greater than or equal to about 10,000, 20,000, 30,000, 40,000, 50,000, 60,000, 70,000, 80,000, 90,000, 100,000, 150,000, 200,000, 250,000, or 300,000 ppm (greater than or equal to about 1, 2, 3, 4, 5, 6, 7, 8, 9, 10, 15, 20, 25, or 30 wt %) TDS. The TDS include the dissolved solids, including dissolved inorganic salts (e.g., monovalent salts (e.g., bicarbonates, chlorides, or sulfates) containing monovalent cations, such as sodium or potassium (e.g., such as sodium chloride (NaCl) or potassium chloride (KCl)), divalent salts (e.g., bicarbonates, chlorides, or sulfates) containing divalent cations, such as magnesium, calcium, or zinc, (e.g., magnesium chloride (MgCl₂), zinc chloride (ZnCl₂) or calcium chloride (CaCl₂)). In embodiments, the TDS water 15 can have a TDS content of greater than or equal to 50,000 ppm (5 wt %) and thus be considered a “high” TDS water, however, lower TDS water can be utilized as TDS water 15, so long as TDS-reduced water 50 comprises less TDS than TDS water 15.

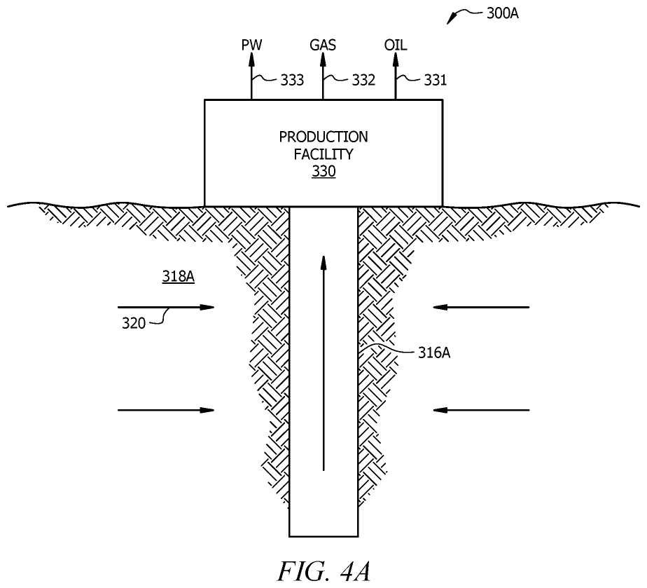

With reference back to FIG. 1, the produced water can be produced at the jobsite and/or at another jobsite. With reference back to FIG. 1, the method can further comprise, at 2, producing the TDS water 15 at the jobsite or another jobsite. In specific embodiments, the jobsite and/or the another jobsite is a well site. In such aspects, at 2, the produced water of TDS water 15 can be produced at the well site of the jobsite and/or the well site of the another jobsite. For example, FIG. 4A depicts a schematic of an exemplary system 300A from which a gas comprising CO₂ 10 and/or a produced water of TDS water 15 can be produced and/or one or more products of method I (e.g., wellbore treatment fluids and/or oil well cement, as described in detail hereinbelow) can be utilized, according to one or more embodiments of the present disclosure. System 300A of FIG. 4A comprises a production well site having a production facility 330 configured to extract production fluid 320 (indicated by the arrows) from a formation 318A via a production well 316A and separate the produced fluids into a produced gas 332, a produced oil (e.g., produced liquid hydrocarbons) 331, and a produced water 333. In aspects, at least a portion of the TDS water 15 comprises produced water 333 produced at the or another jobsite. In aspects, at least a portion of the gas comprising CO₂ 10 is produced at the or another system 300A from which the produced water of TDS water 15 is obtained.

The proton removing agent 20 can be selected from hydroxides, organic bases, super bases, oxides, ammonia, carbonates, another proton-removing agent, or combinations thereof. For example, in aspects, the proton-removing agent 20 comprises a hydroxide selected from sodium hydroxide (NaOH), potassium hydroxide (KOH), calcium hydroxide (Ca(OH)₂), or magnesium hydroxide (Mg(OH)₂); an organic base selected from primary amines, secondary amines, tertiary amines, aromatic amines, heteroaromatics, or combinations thereof, for example, pyridine, methylamine, imidazole, diisopropylamine, diisopropylethylamine, aniline, benzimidazole, histidine, phophazene, or a combination thereof. In aspects, the proton-removing agent 20 does not include an amine.

With reference now to FIG. 1, at 3, the gas comprising CO₂ 10 (e.g., obtained from the exhaust gas of fracturing equipment at the jobsite (or by trucking in captured CO₂ from another jobsite, such as from a power plant, cement plant, etc.) introduced into the precipitation reactor 30 contacts the TDS water 15 (e.g., consisting of or including produced water) and the one or more proton-removing agents 20. Within precipitation reactor 30, the CO₂ of the gas comprising CO₂ 10 reacts with the TDS water 15 to form carbonic acid (H₂CO₃).

Mixing the gas comprising CO₂ 10 with the TDS water 15 allows CO₂ to be solvated to provide an aqueous solution of CO₂, as indicated in Equation (1):

CO₂(g)→CO₂(aq) (1).

The CO₂ dissolves in the TDS water 15 to provide aqueous carbonic acid, as indicated in Equation (2):

CO₂(aq)+H₂O(liq)↔H₂CO₃(aq) (2).

Carbonic acid is a weak acid which dissociates in two steps. With pH of the solution below about 8 to 9, bicarbonate is formed in Step 1.

H₂CO₃(aq)+H₂O↔H₃O⁺(aq)+HCO₃⁻(aq) Step 1.

With pH of the solution above about 9 to 10 (by adding proton-removing agent 20 (e.g., a hydroxide (OH⁻) source), carbonate is formed in Step 2.

HCO₃⁻(aq)+OH⁻↔CO₃²⁻(aq)+H₂O Step 2.

Thus, the proton-removing agent(s) 20 captures the hydronium ions (H₃O⁺) that have been generated from carbonic acid (H₂CO₃) in forming bicarbonate (HCO₃⁻) and carbonate (CO₃²⁻) ions. The divalent metal cations, i.e., Ca²⁺ and/or Mg²⁺, existing in the TDS water 15 react with CO₃²⁻ to form a precipitate including one or more carbonates, such as solids of calcium carbonate (CaCO₃) and/or magnesium carbonate (MgCO₃) that will precipitate out of the TDS water 15. Reaction of metal cations with carbonate anion forms metal carbonate solids or “precipitate” via Equation (3):

mX(aq)+nCO₃²⁻↔Xₘ(CO₃)ₙ(s) (3)

wherein X is a metal cation (or a combination of metal cations) that can chemically bond with a carbonate group; m and n are stoichiometric positive integers. For example, when the TDS water 15 comprises the metal cations Ca²⁺ and/or Mg²⁺, the reactions of Equation (4) and Equation (5) can occur:

Ca²⁺+CO₃²⁻→CaCO₃ (4)

Mg²⁺+CO₃²⁻→MgCO₃ (5)

Thus, in embodiments, the dissolution of CO₂ into the TDS water 15 (e.g., the aqueous solution of divalent cations) produces carbonic acid, a species in equilibrium with both bicarbonate and carbonate. To produce precipitation solids comprising the one or more carbonates, protons are removed from various species (e.g. carbonic acid, bicarbonate, hydronium, etc.) in the TDS water 15 (e.g., the divalent cation-containing solution) to shift the equilibrium toward forming carbonate, and allowing rapid precipitation of carbonate-containing solids. As protons are removed, more CO₂ goes into solution.

Reacting at 3 of the TDS water 15 and the gas containing CO₂ 10 in the presence of the proton-removing agent 20 within precipitation reactor 30 provides CO₂-reduced gas 32, that may be obtained from precipitation reactor 30. CO₂-reduced gas 32 can comprise a clean air that can, in embodiments, be suitable for venting and/or other use without further treatment. In aspects, the CO₂-reduced gas 32 comprises air having less than 0.01, 0.1, or 1.0 volume percent (vol %) CO₂ and/or comprises less than 1, 2, 3, 4, 5, 6, 7, 8, 9, 10, or 15 vol % of the CO₂ in the gas comprising CO₂ 10.

With reference to FIG. 1, method I can include, at 4, separating at least a portion of the water from the aqueous product 31 to provide a concentrated slurry 42 of the precipitate and a TDS-reduced water 50. With reference to FIG. 2, system II includes a solid/liquid separator 40 configured to effect the separation of the portion of the water from the aqueous product 31 to provide the concentrated slurry 42 of the precipitate and the TDS-reduced water 50. The concentrated slurry 42 of the precipitate can be removed from the solid/liquid separator 40 via slurry line 42, and the TDS-reduced water 50 can be removed from solid/liquid separator 40 via a liquid line 41. Solid/liquid separator 40 can be any separator operable to separate at least a portion of the water from the aqueous product 31. By way of non-limiting examples, solid/liquid separator 40 can comprise a filter, a centrifuge, or a gravity settler.

The TDS-reduced water 50 comprises less TDS than the TDS water 15. In aspects, the TDS water 15 comprises greater than or equal to about 1, 5, or 30, or from about 0.1 to about 30, from about 1 to about 25, or from about 3 to about 20 weight percent (wt %) TDS. In aspects, the TDS-reduced water 50 comprises less than or equal to about 0.01, 0.1, or 1.0, or from about 0.001 to about 1, from about 0.01 to about 0.5, or from about 0.1 to about 0.3 weight percent (wt %) TDS. In aspects, the TDS-reduced water 50 comprises less than or equal to about 0.05, 0.1, or 0.5 weight percent (wt %) of the TDS in the TDS water 15.

With reference back to FIG. 1, method I can further comprise, at 5, utilizing at least a portion of the TDS-reduced water, optionally subsequent further treatment, at the or another jobsite. Utilizing the portion of the TDS-reduced water 50, optionally subsequent the further treatment, at the jobsite or the another jobsite, at 5, can comprise utilizing the portion of the TDS-reduced water 50, optionally subsequent the further treatment, as a component of a fluid being injected into a well (e.g., at the jobsite or the another jobsite) during a wellbore servicing operation. The wellbore servicing operation can, without limitation, be selected from acidizing, cementing, gravel packing, hydraulic fracturing, frac-packing, stimulating, working over, another wellbore servicing operation, or a combination thereof. In some embodiments, the wellbore servicing operation comprises a hydraulic fracturing operation. In some such embodiments, the fluid being injected into the well can comprise a fracturing fluid. By way of example, the fracturing fluid can comprise a slickwater, which is a water treated with a friction reduction agent. Alternatively or additionally, utilizing the portion of the TDS-reduced water 50, optionally subsequent the further treatment, at the jobsite or the another jobsite comprises utilizing the portion of the TDS-reduced water 50, optionally subsequent the further treatment, at the jobsite or the another jobsite as irrigation water, as a component of a fluid being utilized during a wellbore servicing operation, as potable water, or a combination thereof.

With reference to FIG. 2, system II can comprise one or more blenders 70A/70B wherein: at least one of the one or more blenders 70A/70B is a bender 70A configured for blending at least a portion of the TDS-reduced water 50, optionally subsequent further treatment, and/or at least a portion of the concentrated slurry of the precipitate 60, optionally subsequent further treatment, to produce a wellbore servicing fluid or composition (collectively referred to herein as a “WSF”) 90A. For example, system II can include one or more WSF blenders 70A fluidly connected with solid/liquid separator 40 (or a vessel or flow line comprising TDS-reduced water 50), configured to combine at least a portion of the TDS-reduced water 50, optionally with at least a portion of the concentrated slurry of the precipitate 60, and/or one or more additives 81A to produce a WSF 90A. The WSF 90A can be removed from the one or more blenders 70A via a WSF line 71A, and can be stored or introduced directly into a wellbore 102. For example, when the WSF comprises a slickwater, the portion of the TDS-reduced water 50 can be combined with an additive of the one or more additives 81A comprising a friction reducer to provide the WSF 90A, that can be introduced downhole during a wellbore servicing operation at the or another jobsite.

FIG. 4B is a schematic of an exemplary system 300B from which a gas comprising CO₂ can be produced and/or one or more products of the method (e.g., wellbore treatment fluids 90A and/or oil well cement, industrial cement, or concrete 90B) can be utilized, according to one or more embodiments of the present disclosure. System 300B can be utilized to deliver the WSF 90A to a downhole location, according to one or more embodiments. It should be noted that while FIG. 4B generally depicts a land-based system, it is to be recognized that like systems may be operated in subsea locations as well. As depicted in FIG. 3, system 300B may include mixing tank 310, in which the WSF 90A of the embodiments herein may be maintained in a mixed state or formulated. In the latter case, mixing tank 310 can be one or more WSF blenders 70A. The WSF 90A may be conveyed via line 312 to wellhead 314, where the WSF 90A enters tubular 316, tubular 316 extending from wellhead 314 into subterranean formation 318B. Upon being ejected from tubular 316, the WSF 90A may subsequently penetrate into subterranean formation 318B. Pump 320 may be configured to raise the pressure of the WSF 90A to a desired degree before introduction into tubular 316B. It is to be recognized that system 300B is merely exemplary in nature and various additional components may be present that have not necessarily been depicted in FIG. 4B in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 4B, the WSF 90A or a portion thereof may, in some embodiments, flow back to wellhead 314 and exit subterranean formation 318B. In some embodiments, the WSF 90A that has flowed back to wellhead 314 may subsequently be recovered and recirculated to subterranean formation 318B, or otherwise treated for use in a subsequent subterranean operation or for use in another industry.

As depicted in FIG. 2, all or a portion of the TDS-reduced water 50 can be subjected to further treatment in treatment apparatus 55 prior to subsequent use. For example, the portion of the TDS-reduced water 50 introduced into the one or more blenders 70A (and/or the one or more cement/concrete blenders 70B discussed hereinbelow) can be subjected to further treatment in treatment apparatus 55. Treatment apparatus 55 can comprise, for example, filtration units or any apparatus operable to remove undesirable components from TDS-reduced water 50 and/or add desirable components to TDS-reduced water 50.

A TDS-reduced water line 54 can be utilized to send TDS-reduced water elsewhere, for example, for utilization as drinking water or for another purpose at the jobsite or another jobsite. This water in water line 54 can also optionally be subjected to further treatment, for example, in treatment apparatus 55 or other treatment apparatus.

As depicted in FIG. 1, method I can further include, at 6, utilizing at least a portion of the concentrated slurry 60 (FIG. 2) comprising the precipitate, or one or more components thereof, optionally subsequent further processing, at the or another jobsite. For example, in embodiments, the portion of the concentrated slurry 60, or the one or more components thereof, can be utilized, optionally subsequent the further processing, at the jobsite or the another jobsite as a component of an oil well cement (e.g., a hydraulic cement), an industrial cement or a concrete, collectively indicated at 90B (FIG. 2). In such embodiments, method I can further include blending the portion of the concentrated slurry 60, or the one or more components thereof, optionally subsequent the further processing, in one or more cement/concrete blenders 70B with one or more components 81B. For example, the one or more components 81B introduced into cement blender 70B can include, without limitation, sand, silica flour, ash (e.g., fly ash), gypsum, lime, clay, Portland cement, other additives, or the like, or a combination thereof. The one or more components 81B and the portion of the concentrated slurry 60, or the one or more components thereof, optionally subsequent the further processing, are blended in cement/concrete blender(s) 70B to produce the oil well cement, the industrial cement or the concrete 90B.

In aspects, the oil well cement, the industrial cement or the concrete 90B is utilized at the or another jobsite. For example, in aspects the cement/concrete blender(s) 70B produce an oil well cement, the and/or the another jobsite is a well site comprising a well, and the method I further comprises utilizing the oil well cement 90B in a cementing operation in the well of the and/or the another jobsite. In some such aspects, the cementing operation can be completed with at least a 1, 2, 3, 4, 5, 6, 7, 8, 9, 10, 20, 30, 40, or 50 weight percent (wt %) reduction in an amount of Portland cement needed for a same cementing operation carried out with an oil well cement absent the portion of the concentrated slurry 60, or the one or more components thereof. Although 90B is described as an oil well cement, an industrial cement, or a concrete, to differentiate such products from those of WSF 90A, product 90B or 90A can comprise an oil well cement. That is WSF 90A or oil well cement, industrial cement, or concrete 90B can comprise an oil well cement.

In aspects, utilizing the concentrated slurry 60, or one or more components thereof, optionally further processing, at 6 comprises utilizing at least a portion of the precipitate as a propping agent (e.g., a proppant) at the or another jobsite. In such aspects, method I can further comprise processing the concentrated slurry 60 in processing apparatus 65 to provide a propping agent. Alternatively, the concentrated slurry 60 can be utilized as a propping agent without further processing. In such aspects, the portion of the concentrated slurry 60 or the one or more components thereof, optionally subsequent further processing in processing apparatus 65, can be blended in one or more WSF blenders 70A, optionally with at least a portion of the TDS-reduced water 50 and/or one or more additives 81A to provide a WSF fluid 90A, which can be a hydraulic fracturing fluid. The fracturing fluid WSF 90A can be introduced downhole via a system, such as the system 300B of FIG. 4B.

The precipitate produced in precipitation reactor 30 can have an average particle size in a range of from about 0.1 micrometer (μm) to about 100 μm; if aggregates of the precipitated particulates form, the aggregates can have size in a range of from a few to about 10 or 20 millimeters or more.

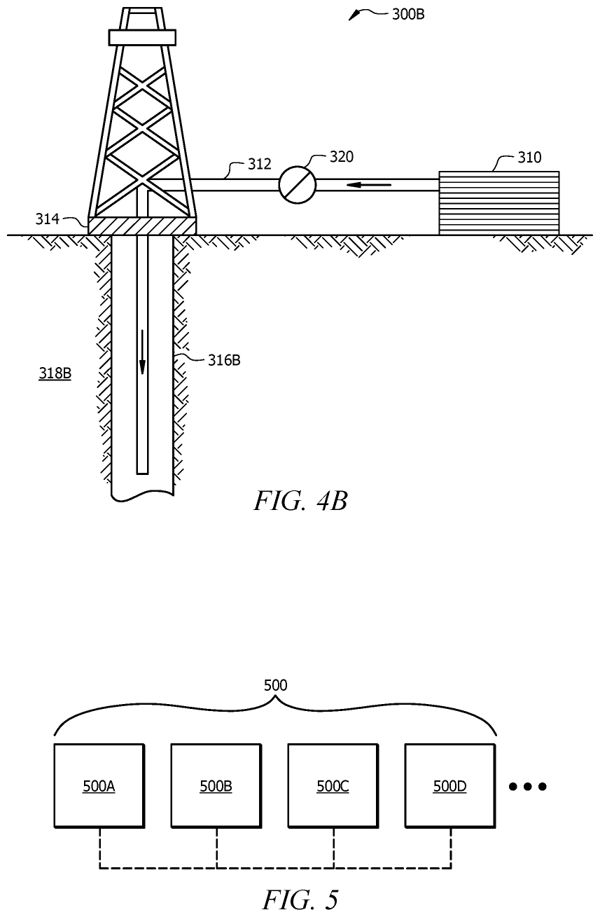

In aspects, at least a portion of the TDS-reduced water 50, at least a portion of the concentrated slurry 60, or both at least a portion of the TDS-reduced water 50 and at least a portion of the concentrated slurry 60 are utilized at the jobsite. In aspects, at least a portion of the TDS-reduced water 50, at least a portion of the concentrated slurry 60, or both at least a portion of the TDS-reduced water 50 and at least a portion of the concentrated slurry 60 comprising the precipitate are utilized at one or more other jobsites. Each of the one or more the blenders 70A/70B can be independently located at the jobsite or at another jobsite. For example, with reference to FIG. 5, which is a schematic representation of one or more jobsites 500 from which the produced water 333 utilized in the TDS water 15 and/or the gas comprising CO₂ 10 can be obtained/produced and/or at which the TDS-reduced water 50 and/or the concentrated slurry 60 comprising the precipitate can be utilized, according to one or more embodiments of this disclosure.

Jobsite 500A can comprise the jobsite at which steps 3 and/or 4 of the method I are performed. Although steps 3 and 4 of method I can be performed at separate jobsites, it may be desirable to perform steps 3 and 4 at the same jobsite 500A. One or more additional jobsites, such as first additional jobsite 500B, second additional jobsite 500C, third additional 500D, and so on, can be a jobsite at which the TDS water 15 (or at least the produced water in TDS water 15) and/or the gas comprising CO₂ (or at least the waste gas from which the gas comprising CO₂ is obtained) is produced. The dotted lines on FIG. 5 indicate that products can be transported between and among the jobsites 500A-500D and so on, for example, transported via pipe, rail, or vehicle.

By way of example, in aspects, jobsite 500A is a well site, and at least one of the one or more cement/concrete blenders 70B configured for blending the portion of the concentrated slurry 60 of the precipitate, optionally subsequent further processing in processing apparatus 65, into the cement or the concrete 90B, and/or at least one of the one or more WSF blenders 70A configured for blending the portion of the concentrated slurry 60 of the precipitate, optionally subsequent further processing in processing apparatus 65, and/or the portion of the TDS-reduced water 50, optionally subsequent further treatment in treatment apparatus 55, into the wellbore servicing fluid 90A is located at the well site of jobsite 500A. Alternatively or additionally, at least one of the additional jobsites 500B-500D and so on, is a construction site, and at least one of the one or more cement/concrete blenders 70B configured for blending the portion of the concentrated slurry 60 of the precipitate into the cement or the concrete 90B is located at the construction site of the at least one of the additional jobsites 500B-500D.

In aspects, the jobsite 500A is a well site at which the gas comprising CO₂ 10 is produced and steps 3 and/or 4 of the method I are performed, first additional jobsite 500B is a well site at which the produced water of TDS water 15 is produced, and at least one of the one or more cement/concrete blenders 70B and/or the WSF blenders 70A is located on first additional jobsite 500B or another of the additional jobsites 500C-500D and so on. In such aspects, a first other blender of the one of the one or more cement/concrete blenders 70B and/or the WSF blenders 70A can be located at a second additional jobsite 500C and/or a second other blender of the one of the one or more cement/concrete blenders 70B and/or the WSF blenders 70A can be located at a third additional jobsite 500D. For example, the first other blender can be a cement/concrete blender 70B at a construction site of second additional jobsite 500C and/or the second other blender can be a WSF blender 70A at a well site disparate from the well site of jobsite 500A at third additional jobsite 500D.

In aspects, the jobsite 500A is a well site at which the gas comprising CO₂ 10 and/or the produced water 15 are produced. In aspects, the jobsite 500A is a well site at which the gas comprising CO₂ 10 is produced and one or more of the additional jobsites 500B-500D are well sites at which the produced water of TDS water 15 is produced. In aspects, the jobsite 500A is a well site at which the produced water of TDS water 15 is produced and one or more of the additional jobsites 500B-500D are well sites at which the gas comprising CO₂ 10 is produced.

Any combination of jobsite 500A and additional jobsites 500B-550D and so on can be utilized to produce the gas comprising CO₂ 10, the TDS water 15, and to utilize the WSF 90A and the oil well cement, industrial cement, or concrete 90B.

Although steps 3 and 4 of the method of this disclosure are described as being performed at jobsite 500A, in alternative embodiments, as noted above, steps 3 and 4 of method I can be performed at different jobsites (e.g., step 3 performed at jobsite 500A and step 4 performed at one of the additional jobsites 500B-500D). Steps 1, 2, 5, and 6 can be performed at the same jobsite 500A at which steps 3 and/or 4 are performed, or can independently be performed at another of the additional jobsites 500B-500D and so on. One or more of steps 1, 2, 5, and 6 can be performed at a same of the additional jobsites 500B-500D and so on, or at disparate of the additional jobsites 500B-500D and so on.

In aspects, a method of this disclosure comprises: reacting, at a well site comprising a well 102, a total dissolved solids (TDS) water 15 with a gas comprising carbon dioxide (CO₂) 10 in the presence of a proton-removing agent 20 to produce a CO₂-reduced gas 32 and an aqueous product 31 comprising water and a precipitate, wherein the TDS water 15 comprises produced water 333, wherein the precipitate comprises one or more carbonates, wherein the CO₂-reduced gas 32 comprises less CO₂ than the gas comprising CO₂ 10, and wherein at least a portion of the gas comprising CO₂ 10 is produced at the well site during a wellbore servicing operation; and separating at least a portion of the water from the aqueous product 31 to produce a concentrated slurry 60 of the precipitate and a TDS-reduced water 50, wherein the TDS-reduced water 50 comprises less TDS than the TDS water 15. The method can further comprise: utilizing at least a portion of the TDS-reduced water 50, optionally subsequent further treatment in treatment apparatus 55, as a component of a WSF 90B being injected into the well 102 at the well site during the wellbore servicing operation or being injected into a second well at a first other well site during a first other wellbore servicing operation; and/or utilizing at least a portion of the concentrated slurry 60 of the precipitate, optionally subsequent further processing in processing apparatus 65, as a component of a cementing fluid 90B being injected into the well 102 at the well site or being injected into a second other well at a second other well site during a second other wellbore servicing operation. The fluid being introduced into the well during the or the first other wellbore servicing operation can comprise a fracturing WSF 90A. In aspects, the method further comprises providing at least a portion of the concentrated slurry 60, optionally subsequent further processing in processing apparatus 65, as a component of a cement or concrete 90B. The portion of the concentrated slurry 60 can be provided as the component of the cement or concrete 90B at a construction site.

Although described herein as performed in one or more blenders 70A/70B, in embodiments, the WSF 90A or the oil well cement, industrial cement, or concrete 90B can be prepared using any suitable method or process. The components of the WSF 90A (e.g., the TDS-reduced water 50, the one or more additives 81A, the concentrated slurry 60 or the one or more components thereof (e.g., when utilized as propping agent), or a combination thereof) and/or the components of the oil well cement, industrial cement, or concrete 90B (e.g., the concentrated slurry 60 and additional components 81A) oil well cement can be combined and mixed in by using any mixing device compatible with the composition, or the e.g., a mixer, a blender, etc.

With reference back to FIG. 4B, which is a schematic of a wellbore servicing system 300B from which the gas comprising CO₂ 10 can be produced and/or one or more products of the method (e.g., wellbore treatment fluids 90A and/or oil well cement, industrial cement, or concrete 90B) can be utilized, according to embodiments of this disclosure, a blender 311 and/or pumps 320 can be utilized to introduce the components of the WSF 90A or the oil well cement, the industrial cement, or the concrete 90B, into a wellbore 102 and/or subterranean formation 318B. The components (i.e., of the WSF 90A and/or of the oil well cement, the industrial cement, of the concrete 90B) can be combined and/or pumped separately via the one or more blenders 70A/70B into the wellbore 102 and/or subterranean formation 318B.

The WSF 90A of this disclosure can be any suitable wellbore servicing fluid (WSF). As used herein, a “servicing fluid” or “treatment fluid” refers generally to any fluid that can be used in a subterranean application in conjunction with a desired function and/or for a desired purpose, including but not limited to fluids used to drill, complete, work over, fracture, repair, or in any way prepare a wellbore for the recovery of materials residing in a subterranean formation penetrated by the wellbore. Examples of wellbore servicing fluids include, but are not limited to, cement slurries, drilling fluids or muds, spacer fluids, lost circulation fluids, fracturing fluids, gravel packing fluids, diverting fluids, or completion fluids. The servicing fluid is for use in a wellbore that penetrates a subterranean formation. It is to be understood that “subterranean formation” encompasses both areas below exposed earth and areas below earth covered by water such as ocean or fresh water. In embodiments, and without limitation, the WSF 90A can be a fracturing fluid, a gravel packing fluid, a stimulation fluid, an acidizing fluid, a conformance control fluid, a clay control fluid, a scale control fluid, an enhanced oil recovery fluid, a surfactant flooding fluid, an energized fluid, a secondary recovery fluid, an injection fluid, or a combination thereof.

The WSF 90A can include a base fluid. The base fluid can be present in a sufficient amount to form a pumpable WSF. For example, in embodiments, the WSF comprises an aqueous base fluid. Herein, an aqueous base fluid refers to a fluid having less than or equal to about 20 vol. %, 15 vol. %, 10 vol. %, 5 vol. %, 2 vol. %, or 1 vol. % of a non-aqueous fluid based on the total volume of the WSF. In embodiments, the aqueous base fluid has a pH of greater than or equal to about −1, 0, 1, 2, 3, 4, 5, 6, 7, or 8, a pH of less than or equal to about 8, 7, 6, 5, 4, 3, 2, 1, or 0. Aqueous base fluids that can be utilized in the WSF 90A include any aqueous fluid suitable for use in subterranean applications, provided that the aqueous base fluid is compatible with any other components of the WSF 90A. For example, the WSF 90A can comprise water or a brine. In embodiments, the base fluid comprises an aqueous brine. In such embodiments, the aqueous brine generally comprises water and an inorganic monovalent salt, an inorganic multivalent salt, or both. The aqueous brine can be naturally occurring or artificially-created. Water present in the brine can be from any suitable source, examples of which include, but are not limited to, sea water, tap water, freshwater, water that is potable or non-potable, untreated water, partially treated water, treated water, produced water, city water, well-water, surface water, or combinations thereof. The salt or salts in the water can be present in an amount ranging from greater than about 0% by weight to a saturated salt solution, alternatively from about 1 wt % to about 18 wt %, or alternatively from about 2 wt % to about 7 wt %, by weight of the aqueous fluid. In embodiments, the salt or salts in the water can be present within the base fluid in an amount sufficient to yield a saturated brine.

Nonlimiting examples of aqueous brines suitable for use in the present disclosure include chloride-based, bromide-based, phosphate-based or formate-based brines containing monovalent and/or polyvalent cations, salts of alkali and alkaline earth metals, or combinations thereof. Additional examples of suitable brines include, but are not limited to: NaCl, KCl, NaBr, CaCl₂, CaBr₂, ZnBr₂, ammonium chloride (NH₄Cl), potassium phosphate, sodium formate, potassium formate, cesium formate, ethyl formate, methyl formate, methyl chloro formate, triethyl orthoformate, trimethyl orthoformate, or combinations thereof. In embodiments, the aqueous fluid comprises a brine. The brine can be present in an amount of from about 40 wt % to about 99.8 wt %, alternatively from about 70 wt % to about 99.5 wt %, or alternatively from about 90 wt % to about 99 wt %, based on the total weight of the WSF 90A. Alternatively, the aqueous base fluid can comprise the balance of the WSF 90A after considering the amount of the other components used.

In embodiments, the (e.g., aqueous) base fluid is present in the wellbore servicing fluid 90A in an amount of from about 40 wt % to about 99.8 wt %, alternatively from about 70 wt % to about 99.5 wt %, or alternatively from about 90 wt % to about 99 wt %, based on the total weight of the WSF.

The components of the WSF 90A can further comprise additional components or additives (e.g., one or more additives 81A) as deemed appropriate for improving the properties of the fluid. Such components or additives can vary depending on the intended use of the fluid in the wellbore. Examples of such additives include, but are not limited to pH adjusting agents, bases, acids, pH buffers, surfactants, emulsifiers, conventional relative permeability modifiers, lime, organic/inorganic viscosifiers, gelling agents, crosslinkers, weighting agents, glass fibers, carbon fibers, suspending agents, clays, clay control agents, fluid loss control additives, dispersants, flocculants, conditioning agents, dispersants, water softeners, acids, foaming agents, proppants, salts, mutual solvents, oxidation and corrosion inhibitors, scale inhibitors, thinners, scavengers, gas scavengers, lubricants, breakers, friction reducers, antifoam agents, bridging agents, and the like, or combinations thereof. These additives 81A can be introduced singularly or in combination using any suitable methodology and in amounts effective to produce the desired improvements in fluid properties.

In embodiments, the WSF 90A further comprises a surfactant and/or demulsifier. Generally, surfactants are amphiphilic molecules that contain a hydrophilic head portion (e.g., polar head group; hydrophilic component) and a hydrophobic tail portion (e.g., non-polar tail group; hydrophobic component; lipophilic component). Typically, the hydrophobic tail portion can be a linear or branched alkyl chain, while the hydrophilic head portion can be a polar functional group (e.g., non-ionic functional group, cationic functional group, anionic functional group). As will be appreciated by one of skill in the art, and with the help of this disclosure, and without being limited by theory, owing to distinct differences in hydrophilicity/hydrophobicity between the hydrophilic head and the hydrophobic tail, surfactants generally reside at interfaces between various phases (e.g., a liquid-solid interface; a liquid-gas interface; a liquid-liquid interface between immiscible liquids; etc.).

Demulsifiers (or emulsion breakers), are a class of chemicals used to separate emulsions, for example, water in oil. In an aspect, the demulsifier prevents and/or breaks an emulsion when it comes in contact with crude oil or breaks an emulsion of the WSF 90A. The demulsifier can include, for example and without limitation, acid catalyzed phenol-formaldehyde resins, base catalyzed phenol-formaldehyde resins, epoxy resins, polyethyleneimines, polyamines, di-epoxides, polyols, dendrimer, silicon particles, silica, alumina, or a combination thereof.

Nonlimiting example of commercially available surfactants (e.g., detergents, emulsions, microemulsions, etc.) suitable for use in the present disclosure include CFS™-485 casing cleaner, LOSURF™-300M surfactant, LOSURF™-357 surfactant, LOSURF™-400 surfactant, LOSURF™-2000S surfactant, LOSURF™-2000M surfactant, LOSURF™-259 nonemulsifier, NEA-96M™ surfactant, BDF™-442 surfactant, and BDF™-443 surfactant. CFS™-485 casing cleaner is a blend of surfactants and alcohols; LOSURF™-300M surfactant is a nonionic surfactant; LOSURF™-357 surfactant is a nonionic liquid surfactant; LOSURF™-400 surfactant is a nonemulsifier; LOSURF™-2000S surfactant is a blend of an anionic nonemulsifier and an anionic hydrotrope; LOSURF™-2000M surfactant is a solid surfactant; LOSURF™-259 nonemulsifier is a nonionic, nonemulsfier blend; NEA-96M™ surfactant is a general surfactant and nonemulsifier; BDF™-442 surfactant and BDF™-443 surfactant are acid-responsive surfactants; all of which are commercially available from Halliburton Energy Services.

Other nonlimiting example of commercially available surfactants (e.g., detergents, emulsions, microemulsions, etc.) suitable for use in the present disclosure include TERGITOL™ 15-S-9 surfactant, which is commercially available from The Dow Chemical Company; TERGITOL™ 15-S-7 surfactant, which is commercially available from The Dow Chemical Company; AMADOL® 511 nonionic alkanolamide water-based mud additive, which is commercially available from Akzo Nobel Surface Chemistry; STEPANOL® WAT-K anionic surfactant, which is commercially available from Stepan; BASAROL® demulsifiers, which are commercially available from BASF; EXXAL™ alcohols, which are commercially available from ExxonMobil; CLEARBREAK® demulsifiers, which are commercially available from Solvay; UNIDYNE™ TG-5543 weak cationic water emulsion, which is commercially available from Daikin; and the like; or combinations thereof.

In some embodiments, the additional component(s) 81A can be present in the WSF 90A in an amount of from about 0.01 wt % to about 10 wt %, alternatively from about 0.01 wt % to about 5 wt %, alternatively from about 0.01 wt % to about 3 wt %, alternatively from about 0.05 wt % to about 2.5 wt %, alternatively from about 0.1 wt % to about 2 wt %, alternatively from about 0.5 wt % to about 1.5 wt %, alternatively from about 0.05 wt % to about 10 wt %, alternatively from about 0.1 wt % to about 7.5 wt %, or alternatively from about 1 wt % to about 5 wt %, based on the total weight of the WSF 90A.

In embodiments, the WSF 90A comprises a pH adjusting agent. In some embodiments, the pH adjusting agent is a base. In other embodiments, the pH adjusting agent is an acid. In some other embodiments, the pH adjusting agent is a pH buffer.

In embodiments, a base can be used for increasing the pH of a solution by about 0.1 pH units, alternatively, about 0.2 pH units, alternatively, about 0.5 pH units, alternatively, about 1.0 pH units, alternatively, about 1.5 pH units, alternatively, about 2.0 pH units, alternatively, about 2.5 pH units, alternatively, about 3.0 pH units, alternatively, about 4.0 pH units, alternatively, about 5.0 pH units, alternatively, about 6.0 pH units, or alternatively, about 7.0 or more pH units.

Nonlimiting examples of bases suitable for use in the present disclosure include ammonium and alkali metal carbonates and bicarbonates, Na₂CO₃, K₂CO₃, CaCO₃, MgCO₃, NaHCO₃, KHCO₃, alkali and alkaline earth metal oxides, BaO, SrO, Li₂O, CaO, Na₂O, K₂O, MgO, alkali and alkaline earth metal hydroxides, NaOH, NH₄OH, KOH, LiOH, Mg(OH)₂, alkali and alkaline earth metal phosphates, Na₃PO₄, Ca₃(PO₄)₂, and the like, or combinations thereof. In embodiments, the base can be included within the WSF 90A in a suitable amount that will provide the desired pH.

In embodiments, an acid can be used for decreasing the pH of a solution by about 0.1 pH units, alternatively, about 0.2 pH units, alternatively, about 0.5 pH units, alternatively, about 1.0 pH units, alternatively, about 1.5 pH units, alternatively, about 2.0 pH units, alternatively, about 2.5 pH units, alternatively, about 3.0 pH units, alternatively, about 4.0 pH units, alternatively, about 5.0 pH units, alternatively, about 6.0 pH units, or alternatively, about 7.0 or more pH units.

Nonlimiting examples of acids suitable for use in the present disclosure include mineral acids, hydrochloric acid, sulphuric acid, sulphonic acid, sulphamic acid; organic acids, formic acid, acetic acid, monochloroacetic acid, dichloroacetic acid, trichloroacetic acid, sulphinic acid, methanesulfonic acid, lactic acid, glycolic acid, oxalic acid, propionic acid, butyric acid; ammonium salts, and salts of weak bases, such as for example organic amines; or combinations thereof. In embodiments, the acid can be included within the WSF 90A in a suitable amount that will provide the desired pH.

In embodiments, the pH adjusting agent is a pH buffer. The pH buffer comprises a combination of weak acids or weak bases, in combination with the corresponding salts to maintain the pH of a fluid in a desired range. Nonlimiting examples of chemical combinations which can be used as pH buffers include acetic acid/sodium acetate; sodium carbonate/sodium bicarbonate; and sodium dihydrogen phosphate/sodium monohydrogen phosphate.

In embodiments, the WSF 90A is an aqueous based fracturing fluid comprising a proppant (which can, in embodiments comprise at least a portion of the concentrated slurry 60, optionally subsequent further processing in processing apparatus 65), surfactants, and an aqueous base fluid.

In embodiments, the wellbore service being performed is a fracturing operation, wherein a WSF 90A is placed (e.g., pumped downhole) in the formation 318A/318B. In such embodiments, the WSF 90A can be a fracturing fluid with a pH of greater than or equal to about 2, 3, 4, 5, or 6. As will be understood by one of ordinary skill in the art, the particular composition of a fracturing fluid will be dependent on the type of formation that is to be fractured. Fracturing fluids typically comprise an aqueous fluid (e.g., water), a proppant, a surfactant, acid, friction reducers, gelling agents, scale inhibitors, pH-adjusting agents, oxygen scavengers, breakers, crosslinkers, iron-control agents, corrosion inhibitors, bactericides, and the like. Such components can comprise additives 81A.

In embodiments, the fracturing fluid comprises a propping agent. In embodiments, the propping agent can comprise any suitable particulate material, which can be used to prop fractures open, i.e., a propping agent or a proppant. As used herein, a proppant refers to a particulate material that is suitable for use in a proppant pack or a gravel pack. When deposited in a fracture, the proppant can form a proppant pack, resulting in conductive channels through which fluids can flow to the wellbore. The proppant functions to prevent the fractures from closing due to overburden pressures.

Nonlimiting examples of proppants suitable for use in this disclosure include silica (sand), graded sand, Ottawa sands, Brady sands, Colorado sands; resin-coated sands; gravels; synthetic organic particles, nylon pellets, high density plastics, teflons, rubbers, resins; ceramics, aluminosilicates; glass; sintered bauxite; quartz; aluminum pellets; ground or crushed shells of nuts, walnuts, pecans, almonds, ivory nuts, brazil nuts, and the like; ground or crushed seed shells (including fruit pits) of seeds of fruits, plums, peaches, cherries, apricots, and the like; ground or crushed seed shells of other plants (e.g., maize, corn cobs or corn kernels); crushed fruit pits or processed wood materials, materials derived from woods, oak, hickory, walnut, poplar, mahogany, and the like, including such woods that have been processed by grinding, chipping, or other form of particleization; or combinations thereof. In embodiments, the proppant comprises sand. In aspects, the propping agent comprises and/or is derived from the concentrated slurry 60 of the precipitate.

The proppants can be of any suitable size and/or shape. In embodiments, a proppant suitable for use in the present disclosure can have an average particle size in the range of from about 2 to about 400 mesh, alternatively from about 8 to about 100 mesh, or alternatively from about 10 to about 70 mesh, U.S. Sieve Series.

In embodiments, a proppant can be present in the WSF 90A in an amount of from about 0.1 pounds per gallon (ppg) to about 28 ppg, alternatively from about 0.1 ppg to about 14 ppg, or alternatively from about 0.1 ppg to about 8 ppg, based on the volume of the fracturing or gravel-packing fluid.

In embodiments, the wellbore service being performed is a gravel packing operation, wherein a WSF 90A is placed (e.g., pumped downhole) in the formation. In such embodiments, the WSF 90A is a gravel packing fluid. A “gravel pack” is a term commonly used to refer to a volume of particulate materials (such as gravel and/or sand) placed into a wellbore to at least partially reduce the migration of unconsolidated formation particulates into the wellbore. Gravel packing operations commonly involve placing a gravel pack screen in the wellbore neighboring a desired portion of the subterranean formation, and packing the surrounding annulus between the screen and the subterranean formation with particulate materials that are sized to prevent and inhibit the passage of formation solids through the gravel pack with produced fluids. In some instances, a screenless gravel packing operation can be performed. In embodiments, the gravel pack comprises a proppant material of the type previously described herein.

### Additional Disclosure

The following are non-limiting, specific embodiments in accordance with the present disclosure:

In a first embodiment, a method comprises: reacting, at a jobsite (e.g., a jobsite associated with one drilling, completing, or servicing or more subterranean wells, also referred to as a pad site or a wellhead site or a well site), a total dissolved solids (TDS) water with an initial feed gas comprising carbon dioxide (CO₂) in the presence of a proton-removing agent to produce a CO₂-reduced gas and an aqueous product comprising water and a precipitate, wherein the TDS water comprises produced water (e.g., water produced from a wellbore at the jobsite or from a wellbore at an adjacent or distant well site and transported to the jobsite), wherein the precipitate comprises one or more carbonates, and wherein the CO₂-reduced gas comprises less CO₂ than the initial feed gas comprising CO₂, and separating at least a portion of the water from the aqueous product to provide a concentrated slurry of the precipitate and a TDS-reduced water, wherein the TDS-reduced water comprises less TDS than the TDS water.

A second embodiment can include the method of the first embodiment, wherein the produced water comprises one or more ions selected from calcium, magnesium, sodium, potassium, aluminum, iron, boron, sulfur, silicon, strontium, or a combination thereof.

A third embodiment can include the method of the first or the second embodiments, wherein the produced water comprises one or more ions, wherein the ions comprise divalent cations, monovalent cations, or a combination thereof.

A fourth embodiment can include the method of the second or third embodiments, wherein the divalent cations include calcium, magnesium, or a combination thereof, and wherein the precipitate includes calcium carbonate, magnesium carbonate, or a combination thereof, respectively.

A fifth embodiment can include the method of any one of the first to fourth embodiments, wherein the TDS water further comprises industrial waste water, seawater, brine, hard water, freshwater, tap water, city water, surface water, river water, lake water, pond water, runoff water, catchment water, or a combination thereof.

A sixth embodiment can include the method of any one of the first to fifth embodiments, wherein the jobsite is a well site comprising one or more wellbores extending from the surface an penetrating a subterranean formation.

A seventh embodiment can include the method of the sixth embodiment, wherein the produced water is a product of a wellbore servicing operation on a well at the or another well site.

An eighth embodiment can include the method of any one of the first to seventh embodiments, wherein the proton removing agent is selected from hydroxides, organic bases, super bases, oxides, ammonia, carbonates, or combinations thereof.

A ninth embodiment can include the method of the eighth embodiment, wherein the hydroxides comprise sodium hydroxide (NaOH), potassium hydroxide (KOH), calcium hydroxide (Ca(OH)₂), or magnesium hydroxide (Mg(OH)₂).

A tenth embodiment can include the method of the eighth embodiment, wherein the organic bases comprise primary amines, secondary amines, tertiary amines, aromatic amines, heteroaromatics, or combinations thereof.

An eleventh embodiment can include the method of the tenth embodiment, wherein the organic bases are selected from pyridine, methylamine, imidazole, diisopropylamine, diisopropylethylamine, aniline, benzimidazole, histidine, phophazene, or combinations thereof.

A twelfth embodiment can include the method of any one of the first to eleventh embodiments, wherein the gas comprising CO₂ is produced at the jobsite, for example via equipment assembled at the jobsite (e.g., well site) for drilling, completing and/or servicing a wellbore at the jobsite.

A thirteenth embodiment can include the method of the twelfth embodiment, wherein the gas comprising CO₂ is a waste gas (e.g., exhaust gas, combustion gas, off gas, flue gas, etc.), or one or more components thereof, produced at one or more well sites or an industrial plant.

A fourteenth embodiment can include the method of the thirteenth embodiment, wherein the one or more industrial plants comprise a cement plant, a chemical processing plant, a mechanical processing plant, a refinery, a steel plant, a power plant (e.g., a gas power plant, a coal power plant), or a combination thereof.

A fifteenth embodiment can include the method of and one of the first to fourteenth embodiments, wherein the waste gas is a product of fuel combustion, for example in a generator or an internal combustion engine.

A sixteenth embodiment can include the method of the fifteenth embodiment, wherein the waste gas is the product of an internal combustion engine.

A seventeenth embodiment can include the method of the sixteenth embodiment, wherein the internal combustion engine comprises an engine that burns a fuel comprising diesel, gasoline, natural gas, or a combination thereof.

An eighteenth embodiment can include the method of any one of the first to seventeenth embodiments further comprising utilizing at least a portion of the TDS-reduced water, optionally subsequent further treatment, at the or another jobsite.

A nineteenth embodiment can include the method of the eighteenth embodiment, wherein utilizing the portion of the TDS-reduced water, optionally subsequent the further treatment, at the jobsite or the another jobsite comprises utilizing the portion of the TDS-reduced water, optionally subsequent the further treatment, as a component of a fluid being placed (e.g., pumped, injected) into a well during a wellbore servicing operation.

A twentieth embodiment can include the method of the nineteenth embodiment, wherein wellbore servicing operation is selected from acidizing, cementing, gravel packing, hydraulic fracturing, frac-packing, stimulating, working over, or a combination thereof.

A twenty first embodiment can include the method of the nineteenth or twentieth embodiments, wherein the wellbore servicing operation comprises a hydraulic fracturing operation, and wherein the fluid comprises a fracturing fluid.

A twenty second embodiment can include the method of the twenty first embodiment, wherein the fracturing fluid comprises a slickwater.

A twenty third embodiment can include the method of any one of the eighteenth to twenty second embodiments, wherein utilizing the portion of the TDS-reduced water, optionally subsequent the further treatment, at the jobsite or the another jobsite comprises utilizing the portion of the TDS-reduced water, optionally subsequent the further treatment, at the jobsite or the another jobsite as irrigation water, as a component of a fluid being utilized during a wellbore servicing operation (e.g., acidizing, cementing, gravel packing, hydraulic fracturing, frac-packing, stimulating, working over, or a combination thereof), as potable water, or a combination thereof.

A twenty fourth embodiment can include the method of any one of the first to twenty third embodiments further comprising utilizing at least a portion of the concentrated slurry, or one or more components thereof, optionally subsequent further processing, at the or another jobsite.

A twenty fifth embodiment can include the method of the twenty fourth embodiment, wherein the portion of the concentrated slurry, or the one or more components thereof, is utilized, optionally subsequent the further processing, at the jobsite or the another jobsite as a component of oil well cement, industrial cement or concrete.

A twenty sixth embodiment can include the method of the twenty fifth embodiment further comprising adding one or more components selected from sand, silica flour, ash (e.g., fly ash), gypsum, lime, clay, Portland cement, other additives, or a combination thereof to the portion of the concentrated slurry, or the one or more components thereof, optionally subsequent the further treatment, to form the oil well cement, the industrial cement or the concrete.

A twenty seventh embodiment can include the method of the twenty fifth or twenty sixth embodiments, wherein the and/or the another jobsite is a well site comprising a well, and wherein the method further comprises utilizing the oil well cement in a cementing operation in the well of the and/or the another jobsite.

A twenty eighth embodiment can include the method of the twenty seventh embodiment, wherein the cementing operation is completed with at least a 1, 2, 3, 4, 5, 6, 7, 8, 9, 10, 20, 30, 40, or 50 weight percent (wt %) reduction in an amount of Portland cement needed for a same cementing operation carried out with a oil well cement absent the portion of the concentrated slurry, or the one or more components thereof.

A twenty ninth embodiment can include the method of any one of the twenty fourth to twenty eighth embodiments, wherein the portion of the concentrated slurry, or the one or more components thereof, is utilized, optionally subsequent the further treatment, during a cementing operation at a construction site.

A thirtieth embodiment can include the method of any one of the first to twenty ninth embodiments further comprising utilizing at least a portion of the precipitate as a propping agent (e.g., a proppant in a fracturing fluid placed downhole as part of a hydraulic fracturing service) at the or another jobsite.

A thirty first embodiment can include the method of the thirtieth embodiment, wherein the precipitate has an average particle size in a range of from about 0.1 micrometer (μm) to about 100 μm.

A thirty second embodiment can include the method of any one of the first to thirty first embodiments, wherein the CO₂-reduced gas comprises air having less than 0.01, 0.1, or 1.0 volume percent (vol %) CO₂ and/or comprising less than 5, 10, or 15 vol % of the CO₂ in the gas comprising CO₂.

A thirty third embodiment can include the method of any one of the first to thirty second embodiments, wherein the TDS water, the gas comprising CO₂, or both the TDS water and the gas comprising CO₂ are produced at the jobsite (e.g., a well site).

A thirty fourth embodiment can include the method of any one of the first to thirty third embodiments, wherein the jobsite is a well site.

A thirty fifth embodiment can include the method of any one of the first to thirty fourth embodiments, wherein at least a portion of the TDS-reduced water, at least a portion of the concentrated slurry, or both at least a portion of the TDS-reduced water and at least a portion of the concentrated slurry are utilized at the jobsite (e.g., well site).

A thirty sixth embodiment can include the method of any one of the first to thirty fifth embodiments, wherein the gas comprising CO₂ comprises greater than or equal to about 30, 40, 50, 60, 70, 80, 90, 95, 96, 97, 98, 99, or 100 volume percent (vol %) CO₂.

A thirty seventh embodiment can include the method of the thirty sixth embodiment, wherein the method further comprises separating the gas comprising CO₂ from a waste gas comprising CO₂. (e.g., a waste gas produced by equipment used in drilling, completing, or servicing a wellbore at the jobsite, for example equipment such a diesel engines powering pumps, generators, blenders, etc.).

A thirty eighth embodiment can include the method of the thirty seventh embodiment, wherein separating the gas comprising CO₂ from the waste gas comprising CO₂ further comprises separating via amine absorption, calcium oxide (CaO) absorption, filtration, packed bed, or a combination thereof.

A thirty ninth embodiment can include the method of the thirty seventh or thirty eighth embodiments, wherein the separating the gas comprising CO₂ from the waste gas comprising CO₂ is effected at another jobsite and the CO₂ is transported post separation (e.g., liquified and transported) to the jobsite.

A fortieth embodiment can include the method of any one of the first to thirty ninth embodiments, wherein the TDS water comprises greater than or equal to about 1, 5, or 30, or from about 0.1 to about 30, from about 1 to about 25, or from about 3 to about 20 weight percent (wt %) TDS, wherein the TDS-reduced water comprises less than or equal to about 0.01, 0.1, or 1.0, or from about 0.001 to about 1, from about 0.01 to about 0.5, or from about 0.1 to about 0.3 weight percent (wt %) TDS and/or wherein the TDS-reduced water comprises less than or equal to about 0.05, 0.1, or 0.5 weight percent (wt %) of the TDS in the TDS water, wherein the TDS comprise dissolved inorganic salts (e.g., monovalent salts (e.g., bicarbonates, chlorides, or sulfates) containing monovalent cations, such as sodium or potassium (e.g., such as sodium chloride (NaCl) or potassium chloride (KCl)), divalent salts (e.g., bicarbonates, chlorides, or sulfates) containing divalent cations, such as magnesium, calcium, or zinc, (e.g., magnesium chloride (MgCl₂), zinc chloride (ZnCl₂) or calcium chloride (CaCl₂)).

A forty first embodiment can include the method of any one of the first to fortieth embodiments, wherein the reacting is carried out in a Venturi reactor, a fluidized bed reactor, a fixed bed reactor, a slurry bubble column reactor, a batch reactor, a semi-batch reactor a continuous stirred tank reactor, a plug flow reactor, or a combination thereof.

A forty second embodiment can include the method of the forty first embodiment, wherein the reacting is carried out in a Venturi reactor.

In a forty third embodiment, a system comprises: a precipitation reactor at a jobsite (e.g., a jobsite associated with one drilling, completing, or servicing or more subterranean wells, also referred to as a pad site or a wellhead site or a well site), wherein the precipitation reactor is configured for reacting a total dissolved solids (TDS) water with an initial feed gas comprising carbon dioxide (CO₂) in the presence of a proton-removing agent to produce a CO₂-reduced gas and an aqueous product comprising water and a precipitate, wherein the TDS water comprises produced water (e.g., water produced from a wellbore at the jobsite or from a wellbore at an adjacent or distant well site and transported to the jobsite), wherein the precipitate comprises one or more carbonates, and wherein the CO₂-reduced gas comprises less CO₂ than the initial feed gas comprising CO₂, and a separator configured for separating at least a portion of the water from the reaction product to produce a concentrated slurry of the precipitate and a TDS-reduced water, wherein the TDS-reduced water comprises less TDS than the TDS water.

A forty fourth embodiment can include the system of the forty third embodiment, wherein the precipitation reactor comprises a Venturi reactor, a fluidized bed reactor, a fixed bed reactor, a slurry bubble column reactor, a batch reactor, a semi-batch reactor a continuous stirred tank reactor, a plug flow reactor, or a combination thereof.

A forty fifth embodiment can include the system of the forty fourth embodiment, wherein the precipitation reactor comprises a Venturi reactor.

A forty sixth embodiment can include the system of the forty third embodiment or the forty fourth embodiment further comprising one or more blenders wherein: at least one of the one or more blenders is configured for blending at least a portion of the concentrated slurry of the precipitate, optionally subsequent further treatment, into or with a cement or a concrete (e.g., to produce a pumpable cement slurry comprising the precipitate); and/or at least one of the one or more blenders is configured for blending at least a portion of the concentrated slurry of the precipitate, optionally subsequent further treatment, and/or at least a portion of the TDS-reduced water, optionally subsequent further treatment, into a wellbore servicing fluid (e.g., a pumpable cementitious slurry).

A forty seventh embodiment can include the system of the forty sixth embodiment, wherein each of the one or more the blenders is independently located at the or another jobsite.

A forty eighth embodiment can include the system of any one of the forty sixth to forty seventh embodiments, wherein the jobsite is a well site, and wherein the at least one of the one or more blenders configured for blending the portion of the concentrated slurry of the precipitate, optionally subsequent further treatment, into the cement or the concrete, and/or the at least one of the one or more blenders configured for blending the portion of the concentrated slurry of the precipitate, optionally subsequent further treatment, and/or the portion of the TDS-reduced water, optionally subsequent further treatment, into the wellbore servicing fluid is located at the well site.

A forty ninth embodiment can include the system of any one of the forty sixth to forty eighth embodiments, wherein the at least one of the one or more blenders configured for blending the portion of the concentrated slurry of the precipitate into the cement or the concrete is located at a construction site.

A fiftieth embodiment can include the system of any one of the forty third to forty ninth embodiments, wherein the jobsite and/or the another jobsite is a well site at which the gas comprising CO₂ and/or the produced water are produced.

In a fifty first embodiment, a method comprises: reacting, at a well site comprising a well, a total dissolved solids (TDS) water with a gas comprising carbon dioxide (CO₂) in the presence of a proton-removing agent to produce a CO₂-reduced gas and an aqueous product comprising water and a precipitate, wherein the TDS water comprises produced water, wherein the precipitate comprises one or more carbonates, wherein the CO₂-reduced gas comprises less CO₂ than the gas comprising CO₂, and wherein at least a portion of the gas comprising CO₂ is produced at the well site during a wellbore servicing operation (e.g., via combustion of fuel from operating wellbore servicing equipment such as diesel engines powering pumps, generators, and blenders); and separating at least a portion of the water from the reaction product to produce a concentrated slurry of the precipitate and a TDS-reduced water, wherein the TDS-reduced water comprises less TDS than the TDS water.

A fifty second embodiment can include the method of the fifty first embodiment, further comprising: utilizing at least a portion of the TDS-reduced water as a component of a fluid being injected into the well at the well site or a well at another well site during the or another wellbore servicing operation; and/or utilizing at least a portion of the concentrated slurry of the precipitate, optionally subsequent further treatment, as a component of the or another fluid being injected into the well at the well site or a well at another well site during the or another wellbore servicing operation.

A fifty third embodiment can include the method of the fifty second embodiment, wherein the fluid being introduced into the well during the wellbore servicing operation or the another wellbore servicing operation comprises a fracturing fluid or a cementitious fluid.

A fifty fourth embodiment can include the method of any one of the fifty first to fifty third embodiments further comprising providing at least a portion of the concentrated slurry, optionally subsequent further processing, as a component of a cement or concrete (e.g., a pumpable cement slurry for placement downhole in the or another wellbore, for example during primary cementing operations, secondary cementing operations, squeeze cementing operations, fluid loss control operations, etc.).

A fifty fifth embodiment can include the method of the fifty fourth embodiment, wherein the portion of the concentrated slurry is provided as the component of the cement or concrete at a construction site or a wellsite (e.g., the or another wellsite).

While embodiments have been shown and described, modifications thereof can be made by one skilled in the art without departing from the spirit and teachings of this disclosure. The embodiments described herein are exemplary only, and are not intended to be limiting. Many variations and modifications of the embodiments disclosed herein are possible and are within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k* (Ru-Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of broader terms such as comprises, includes, having, etc. should be understood to provide support for narrower terms such as consisting of, consisting essentially of, comprised substantially of, etc. When a feature is described as “optional,” both embodiments with this feature and embodiments without this feature are disclosed. Similarly, the present disclosure contemplates embodiments where this “optional” feature is required and embodiments where this feature is specifically excluded.

Accordingly, the scope of protection is not limited by the description set out above but is only limited by the claims which follow, that scope including all equivalents of the subject matter of the claims. Each and every claim is incorporated into the specification as embodiments of the present disclosure. Thus, the claims are a further description and are an addition to the embodiments of the present disclosure. The discussion of a reference herein is not an admission that it is prior art, especially any reference that can have a publication date after the priority date of this application. The disclosures of all patents, patent applications, and publications cited herein are hereby incorporated by reference, to the extent that they provide exemplary, procedural, or other details supplementary to those set forth herein.

What is claimed is:

1. A method comprising:
reacting, at a jobsite, a total dissolved solids (TDS) water with a gas comprising carbon dioxide (CO₂) in the presence of a proton-removing agent to produce a CO₂-reduced gas and an aqueous product comprising water and a precipitate, wherein the TDS water comprises produced water, wherein the precipitate comprises one or more carbonates, and wherein the CO₂-reduced gas comprises less CO₂ than the gas comprising CO₂, and
separating at least a portion of the water from the aqueous product to provide a concentrated slurry of the precipitate and a TDS-reduced water, wherein the TDS-reduced water comprises less TDS than the TDS water.

2. The method of claim 1, wherein the produced water comprises divalent cations, wherein the divalent cations include calcium, magnesium, or a combination thereof, and wherein the precipitate includes calcium carbonate, magnesium carbonate, or a combination thereof, respectively.

3. The method of claim 1, wherein the jobsite is a well site, and wherein the produced water is a product of a wellbore servicing operation on a well at the or another well site.

4. The method of claim 1, wherein the gas comprising CO₂ is produced at the jobsite.

5. The method of claim 1 further comprising:
utilizing at least a portion of the TDS-reduced water, optionally subsequent further treatment, at the jobsite or another jobsite; and/or
utilizing at least a portion of the concentrated slurry, or one or more components thereof, optionally subsequent further processing, at the jobsite or another jobsite.

6. The method of claim 5 comprising utilizing the portion of the TDS-reduced water, optionally subsequent further treatment, at the jobsite or the another jobsite:
wherein utilizing the portion of the TDS-reduced water, optionally subsequent the further treatment, at the jobsite or the another jobsite comprises utilizing the portion of the TDS-reduced water, optionally subsequent the further treatment, as a component of a fluid being injected into a well during a wellbore servicing operation; and/or
wherein utilizing the portion of the TDS-reduced water, optionally subsequent the further treatment, at the jobsite or the another jobsite comprises utilizing the portion of the TDS-reduced water, optionally subsequent the further treatment, at the jobsite or the another jobsite as irrigation water, as a component of a fluid being utilized during a wellbore servicing operation, as potable water, or a combination thereof.

7. The method of claim 5 comprising utilizing the portion of the concentrated slurry, or the one or more components thereof, optionally subsequent the further processing, at the jobsite or the another jobsite:
wherein the portion of the concentrated slurry, or the one or more components thereof, is utilized, optionally subsequent the further processing, at the jobsite or the another jobsite as a component of oil well cement, industrial cement or concrete; wherein the portion of the concentrated slurry, or the one or more components thereof, is utilized, optionally subsequent the further processing, during a cementing operation at a construction site; and/or
utilizing the portion of the concentrated slurry, or the one or more components thereof, optionally subsequent the further processing, at the jobsite or the another jobsite comprises utilizing at least a portion of the precipitate as a propping agent at the or another jobsite.

8. The method of claim 1, wherein the TDS water, the gas comprising CO₂, or both the TDS water and the gas comprising CO₂ are produced at the jobsite.

9. The method of claim 1, wherein at least a portion of the TDS-reduced water, at least a portion of the concentrated slurry, or both at least a portion of the TDS-reduced water and at least a portion of the concentrated slurry are utilized at the jobsite.

10. The method of claim 1, wherein the method further comprises separating the gas comprising CO₂ from a waste gas comprising CO₂, wherein the separating the gas comprising CO₂ from the waste gas comprising CO₂ is effected at another jobsite and transported to the jobsite.

11. The method of claim 1, wherein the reacting is carried out in a Venturi reactor, a fluidized bed reactor, a fixed bed reactor, a slurry bubble column reactor, a batch reactor, a semi-batch reactor a continuous stirred tank reactor, a plug flow reactor, or a combination thereof.

12. A system comprising:
a precipitation reactor at a jobsite, wherein the precipitation reactor is configured for reacting a total dissolved solids (TDS) water with a gas comprising carbon dioxide (CO₂) in the presence of a proton-removing agent to produce a CO₂-reduced gas and an aqueous product comprising water and a precipitate, wherein the TDS water comprises produced water, wherein the precipitate comprises one or more carbonates, and wherein the CO₂-reduced gas comprises less CO₂ than the gas comprising CO₂; and
a separator configured for separating at least a portion of the water from the reaction product to produce a concentrated slurry of the precipitate and a TDS-reduced water, wherein the TDS-reduced water comprises less TDS than the TDS water.

13. The system of claim 12:
wherein the precipitation reactor comprises a Venturi reactor, a fluidized bed reactor, a fixed bed reactor, a slurry bubble column reactor, a batch reactor, a semi-batch reactor a continuous stirred tank reactor, a plug flow reactor, or a combination thereof; and/or
wherein the jobsite is a well site at which the gas comprising CO₂ and/or the produced water are produced.

14. The system of claim 12 further comprising one or more blenders wherein:
at least one of the one or more blenders is configured for blending at least a portion of the concentrated slurry of the precipitate, optionally subsequent further treatment, into an oil well cement, an industrial cement, or a concrete; and/or
at least one of the one or more blenders is configured for blending at least a portion of the concentrated slurry of the precipitate, optionally subsequent further treatment, and/or at least a portion of the TDS-reduced water, optionally subsequent further treatment, into a wellbore servicing fluid.

15. The system of claim 14:
wherein each of the one or more the blenders is independently located at the or another jobsite;
wherein the jobsite is a well site, and wherein the at least one of the one or more blenders configured for blending the portion of the concentrated slurry of the precipitate, optionally subsequent further treatment, into the oil well cement, the industrial cement, or the concrete, and/or the at least one of the one or more blenders configured for blending the portion of the concentrated slurry of the precipitate, optionally subsequent further treatment, and/or the portion of the TDS-reduced water, optionally subsequent further treatment, into the wellbore servicing fluid is located at the well site; and/or
wherein the at least one of the one or more blenders configured for blending the portion of the concentrated slurry of the precipitate into the oil well cement, the industrial cement or the concrete is located at a construction site.

16. A method comprising:
reacting, at a well site comprising a well, a total dissolved solids (TDS) water with a gas comprising carbon dioxide (CO₂) in the presence of a proton-removing agent to produce a CO₂-reduced gas and an aqueous product comprising water and a precipitate, wherein the TDS water comprises produced water, wherein the precipitate comprises one or more carbonates, wherein the CO₂-reduced gas comprises less CO₂ than the gas comprising CO₂, and wherein at least a portion of the gas comprising CO₂ is produced at the well site during a wellbore servicing operation; and
separating at least a portion of the water from the reaction product to produce a concentrated slurry of the precipitate and a TDS-reduced water, wherein the TDS-reduced water comprises less TDS than the TDS water.

17. The method of claim 16 further comprising:
utilizing at least a portion of the TDS-reduced water, optionally subsequent further treatment, as a component of a fluid being injected into the well at the well site or a well at another well site during the or another wellbore servicing operation; and/or
utilizing at least a portion of the concentrated slurry of the precipitate, optionally subsequent further processing, as a component of the or another fluid being injected into the well at the well site or a well at another well site during the or another wellbore servicing operation.

18. The method of claim 17, wherein the fluid being introduced into the well during the wellbore servicing operation or the another wellbore servicing operation comprises a fracturing fluid.

19. The method of claim 16 further comprising providing at least a portion of the concentrated slurry, optionally subsequent further processing, as a component of an oil well cement, an industrial cement, or a concrete.

20. The method of claim 19, wherein the portion of the concentrated slurry is provided as the component of the oil well cement, the industrial cement, or the concrete at a construction site.
